(19) United States
(12) Patent Application Publication
(10) Pub. No.: US 2011/0220300 A1
(43) Pub. Date: Sep. 15, 2011

(54) Method, system and kit for fastening shade blinds

(76) Inventor: John Sengelaub, Deer Park, NY (US)

(21) Appl. No.: 12/661,064

(22) Filed: Mar. 9, 2010

(51) Int. Cl. E06B 9/24; A47H 5/00; A44B 18/00; B23P 17/04

(52) U.S. Cl. 160/84.04; 24/447; 29/401.1

(57) ABSTRACT

A method, a kit and a system for providing removably attachable fasteners made of hooks and loops to guide rings of blinds such as Roman Shades. The Roman Shades are removably attached and secured to the guide rings by the hooks and loops fasteners.

### BACKGROUND

1. Field

The present disclosure relates to a method, a kit and a system for fastening shades and in particular Roman Shades with fastening devices. In particular, the present invention relates to a method, a kit and a system for attaching a removable attachable fastener made of hooks and loops to the guide rings of shade such as Roman Shades. The hooks and loops fasteners would replace the stitching on the guide rings that hold the guide rings in place on the shades.

2. Description of the Related Art

U.S. Pat. No. 3,777,800 to Susoev discloses a roman shade in which a hooks and loops type fastener is provided in an upper margin of the fabric. This reference does not disclose providing fastening means on the rings. U.S. Pat. No. 7,195,051 to Nien discloses fastening means on an end of a lateral blind.

A problem is presented with Roman Shade blinds. Exposed control cords on the back of a Roman Shade blind have been identified as a strangulation hazard. It therefore would be preferable to remove the sewn-in control rings on the back of the shade of the Roman Shade blinds and reattach with hook and loop fasteners by providing a kit that offers such an option and thereby reduce the hazard by allowing the rings to break free if a child places his or her head or neck in the loops created by the control rings on the back of the Roman Shade blinds.

### SUMMARY

The present disclosure provides for a method, a kit and a system for providing removably attachable fasteners made of hooks and loops to guide rings of blinds such as Roman Shades. In this way, the Roman Shades are removably attached and secured to the guide rings by the hooks and loops fasteners.

### BRIEF DESCRIPTION OF THE DRAWINGS

FIG. 1 illustrates the exposed control cords on the back of a typical Roman Shade known in the art that can present a strangulation hazard particularly for a child;

FIG. 2 illustrates a hooks and loop fastener for attachment to a guide ring in accordance with the present disclosure;

FIG. 3 illustrates a first step in retro fitting the bottom rings of a Roman Shade blind with cord release system in accordance with the present disclosure;

FIG. 4 illustrates a second step in retro fitting the bottom rings of a Roman Shade blind with cord release system in accordance with the present disclosure;

FIGS. 5 and 6 illustrate a third step in retro fitting a Roman Shade blind with cord release system in accordance with the present disclosure in which:

FIG. 5 illustrates feeding the soft side of the hooks and loops fastener through the guide ring and positioning the bottom ring in the center of the hooks and loops fastener strip; and

FIG. 6 illustrates attaching the two hooks and loops fastener;

FIG. 7 illustrates a first step in retro fitting the guide rings of a Roman Shade blind with cord release system in accordance with the present disclosure;

FIG. 8 illustrates a second step in retro fitting the guide rings of a Roman Shade blind with cord release system in accordance with the present disclosure;

FIGS. 9 and 10 illustrate a third step in retro fitting the guide rings of Roman Shade blind with cord release system in accordance with the present disclosure in which:

FIG. 9 illustrates feeding a soft side of the hooks and loops fastener through the guide ring and positioning the ring in the center of the hooks and loop fastener strip; and

FIG. 11 illustrates what the completed Roman Shade retro fitted with the cord release system in accordance with the present disclosure looks like.

### DETAILED DESCRIPTION OF THE PREFERRED EMBODIMENT(S)

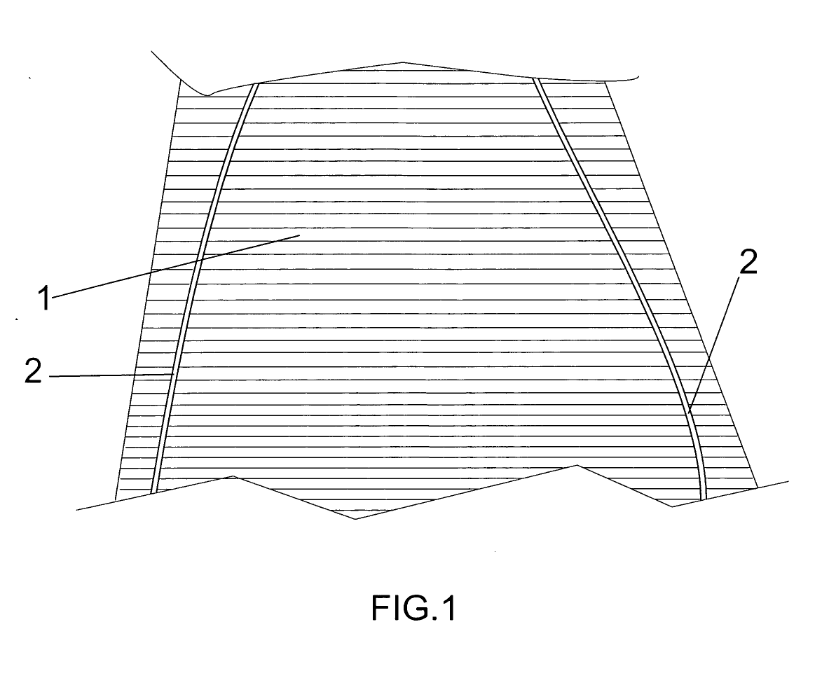

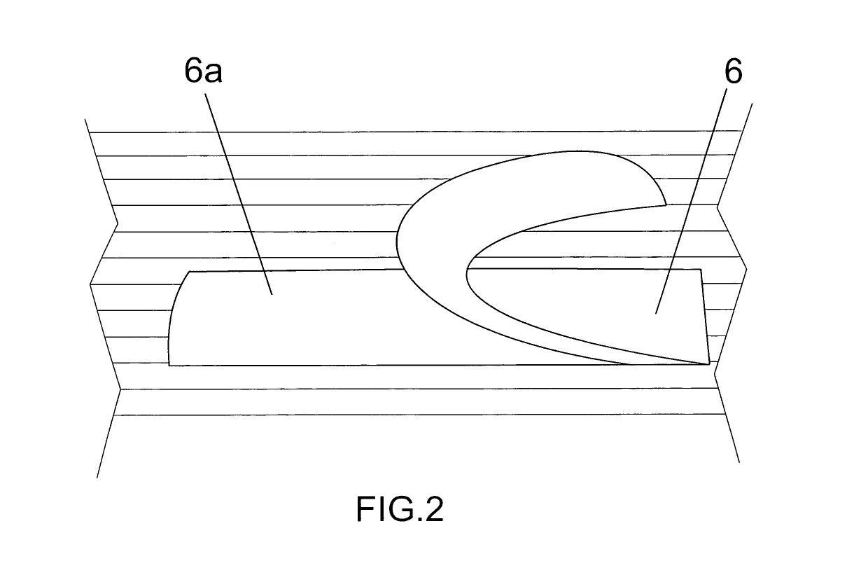

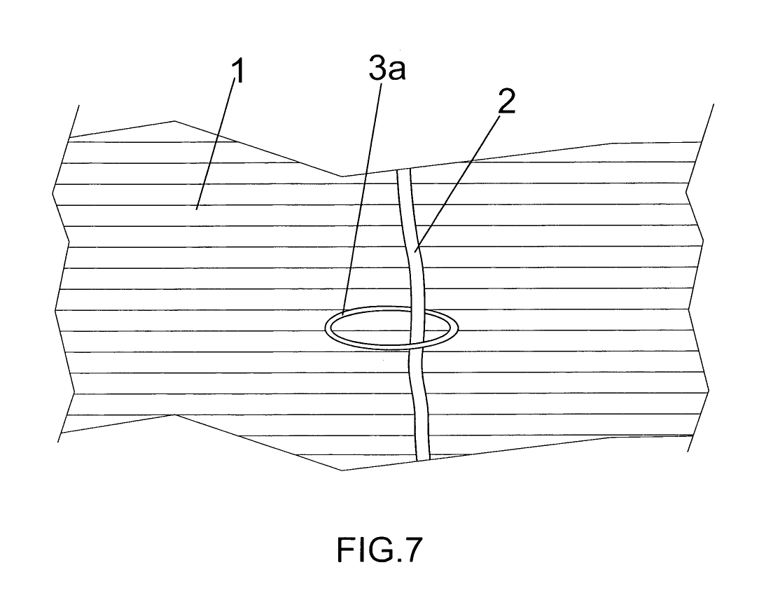

Referring now to the drawings of FIGS. 1-11, FIG. 1 illustrates the problem associated with the known Roman Shade 1 and in particular an identified strangulation hazard for the exposed control cords 2 of the Roman Shade 1. The control rings 3 are typically sewn into onto the back of the Roman Shade 1. This creates a hazard for someone, particularly a child, if a child places his or her head into the loops created by the control rings 3 on the back of the Roman Shade 1. The present disclosure as illustrated in FIGS. 2-11 of the drawings provides a method, a system and a kit for retro fitting a Roman Shade 1 with a cord release system so that this hazard is reduced by allowing the rings to break free should a child place his or her head or neck in loops created in the back of the Roman Shade 1.

FIG. 2 illustrates a hooks and loops fastener 6 such as but not limited to a Velcro brand strip fastener 6. The kit of the present disclosure would include preferably 3 hooks and loop fastener strips 6 for bottom rings 3 of the Roman Shade and 8 hooks and loops fastener strips 6 for guide rings of the Roman Shade. Preferably the three hooks and loops fastener strips 6 in the kit for the bottom rings 3 would be 1½ inches in length by ⅜ of an inch in width. The eight hooks and loops fastener strips 6 for the guide rings 3a in the kit would preferably be ¾ inch in length by ⅜ of an inch in width. The kit would also include instructions for the procedure in each of the steps described below.

The Roman Shade 1 should be removed and laid flat with its back facing up as shown in FIG. 1.

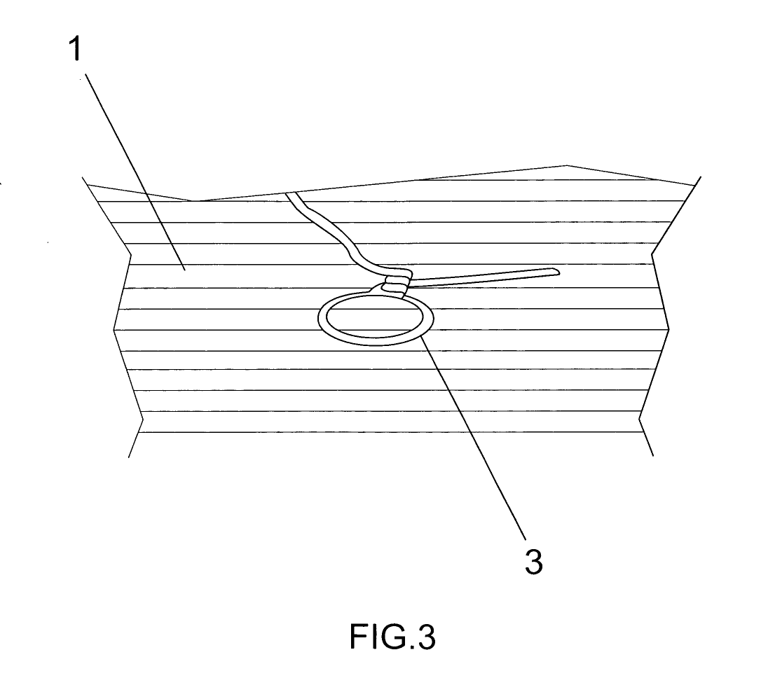

The first step in accordance with the present disclosure for retro fitting the bottom rings 3 of the Roman Shade 1 is to cut the strings that attach each of the bottom rings 3 to the back of the shade 1 and mark each of these positions with a soft pencil as shown in FIG. 3 for one of the bottom rings 3. It is important to remember not to cut or untie the control cord that is tied to the ring.

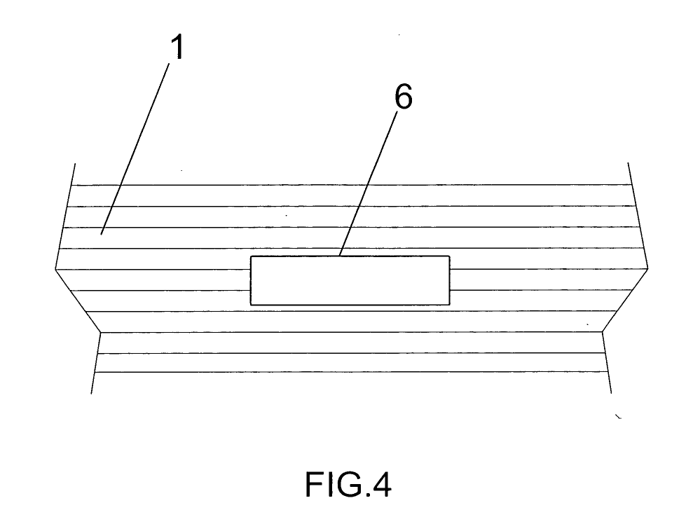

The hooks and loops fastener strip 6 is then peeled back off the latch side 6a (see FIG. 1) and placed to adhere to the back side of the shade where the bottom ring 3 was detached (see FIG. 4).

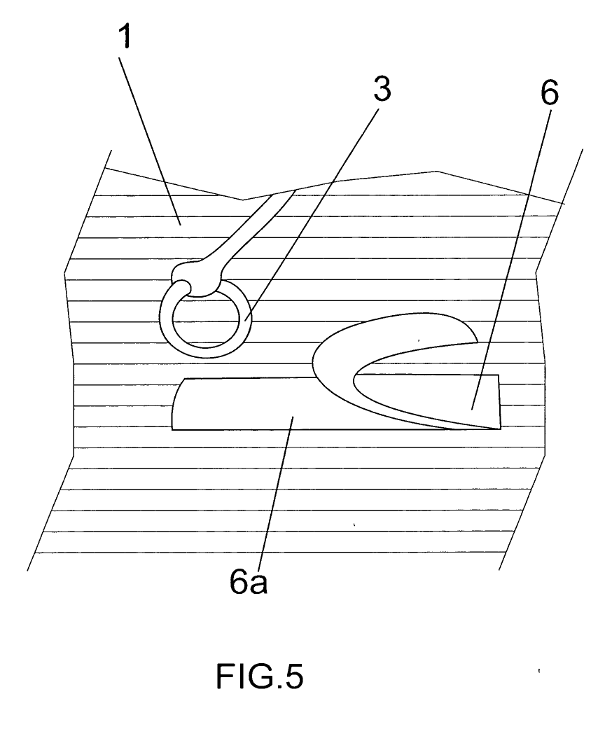

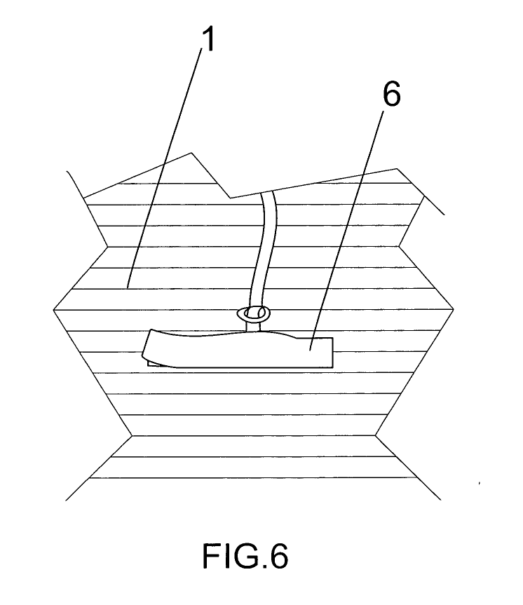

The third step of the method of the present disclosure for thereto fitting the bottom rings 3 of the Roman Shade 3 is feeding the soft side of the hooks and loops fastener 6 through the guide ring 3a and positioning the bottom ring 3 in the center of the hooks and loops fastener strip 6 (FIG. 5). The two strips 6 are then the attached by pressing the strips gently (see FIG. 6). This procedure of step 3 as shown in FIGS. 5 and 6 is repeated for both bottom rings 3.

The guide rings 3a of the Roman Shade 1 are retro fitted in accordance with the present disclosure as follows:

The first step for retro fitting the guide rings 3a of the Roman Shade 1 in accordance with the present disclosure is for the strings that attach the guide rings 3a to the back of the shade 1 are cut. These are the rings 3a that the cord goes through. This position is marked preferably with a soft pencil. The control cord should not be cut or untied.

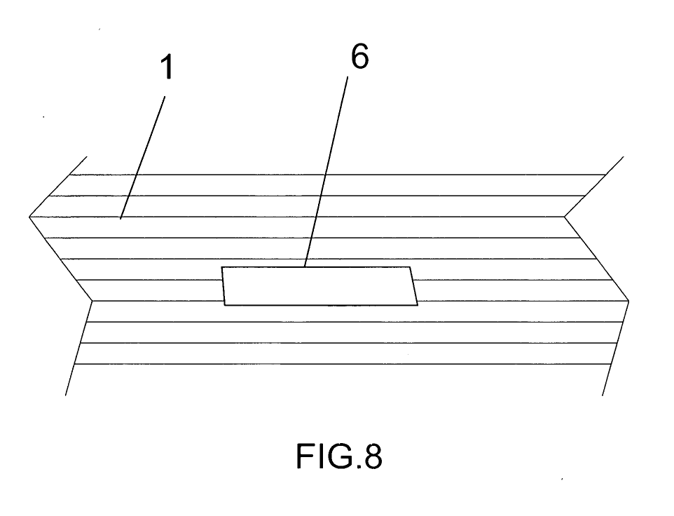

The second step is to peel off the back tape of the latch side 6a of the hooks and loops fastener strip 6 preferably ¾ inch (length) by ⅜ inch (width) and placed to adhere to the back of the shade 1 where the guide ring 3a was detached. (See FIG. 8).

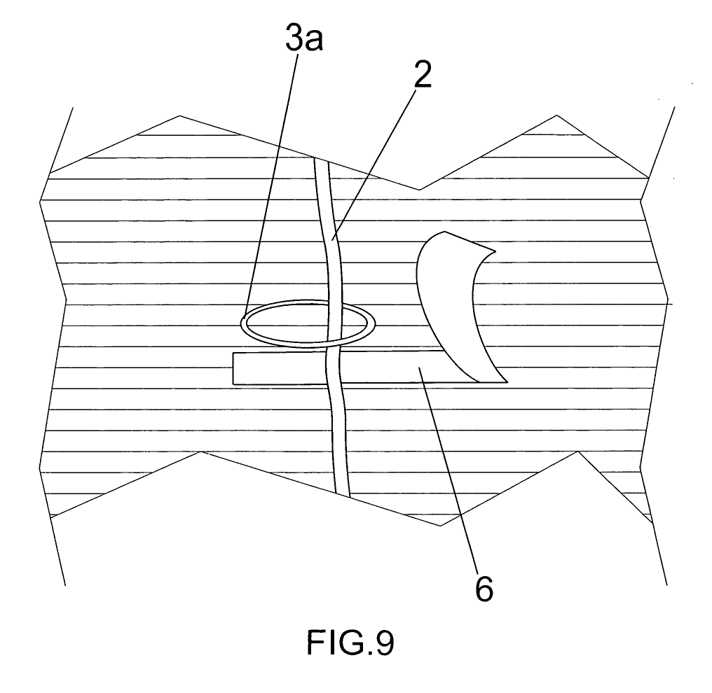

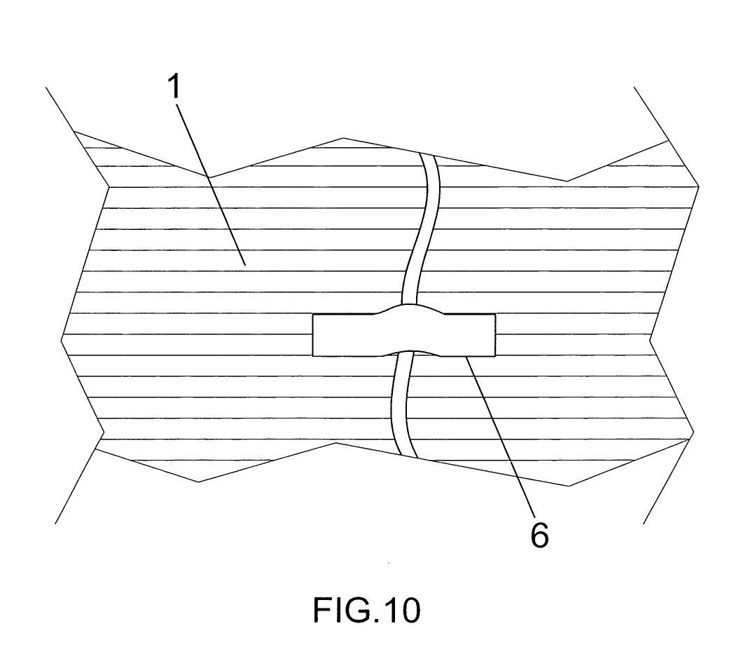

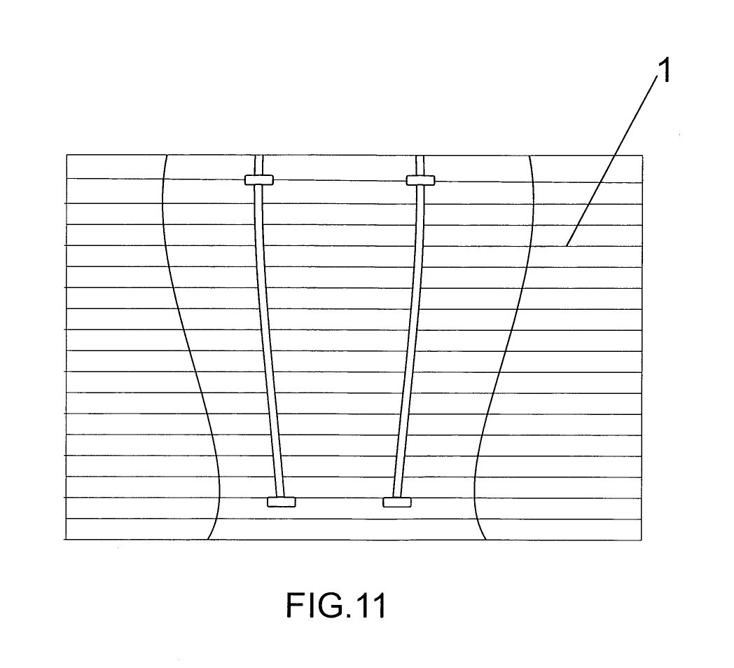

The third step of the method of the present disclosure for fitting the guide rings 3a of the Roman Shade 1 is feeding the soft side of the hooks and loops fastener through the guide ring 3a and positioning the ring in the center of the hooks and loops fastener strip 6 (FIG. 9). The two strips are then attached by pressing the strips 6 gently (see FIG. 10). This procedure is repeated for all the guide rings 3a. When completed, the retrofitted Roman Shade 1 should look like the shade 1 shown in FIG. 11.

When pressure is exerted on the cord of thus described retrofitted Roman Shade 1 shown in FIG. 11 the hooks and loops fasteners 6 should easily release the guide 3a or bottom rings 3. Normal operation of the shade I will be effected by the placement of the hooks and loops fasteners 6. When the hooks and loops fasteners 6 are released the guide rings 3a will slide down the cord and be caught by the bottom ring 3, which is tied to the control cord. To reattach the rings, simply repeat step 3 of the procedure described above.

While certain embodiments have been shown and described, it is distinctly understood that the invention is not limited thereto, but may be otherwise embodied within the scope of the appended claims.

What is claimed:

1. A cord release system for fastening a guide ring to a shade, comprising:
a Roman Shade including bottom rings and guide rings
a hooks and loops fastener adapted to be applied to the guide rings and bottom rings wherein strings attaching the bottom rings to a back surface of the shade and guide rings to the back surface, of the shade are cut and hook and loops fasteners are fed through the guide rings and the bottom rings so as to form a removably attachable fastener between the guide rings and the bottom rings and the shade so that when pressure is exerted on the cord of thus described retrofitted Roman Shade the hooks and loops fasteners releases the guide rings and/or bottom rings.

2. The system according to claim 1 wherein
there are three hooks and loops fastener strips for the bottom rings and these fastener strips are 1½ inches in length by ⅜ of an inch in width.

3. The system according to claim 1 wherein there are eight hooks and loops fastener strips for the guide rings and they are preferably ¾ inch in length by ⅜ of an inch in width.

4. A method for retro fitting a Roman Shade with a cord release system, the steps comprising:
cutting strings that are attached to each bottom ring of the back of the Roman Shade;
marking each position where each string was cut for each of said bottom rings;
peeling off a backing of a hooks and loops fastener strip for each bottom ring from its latch side and placing each strip to adhere to the back side of the Roman Shade where each bottom ring was detached;
feeding the soft side of the hooks and loops fastener through each ring and positioning each bottom ring in the center of the hooks and loops fastener strip;
attaching the strips by pressing the strips and repeating for each bottom ring.
cutting the strings that attach the guide rings to the back of the shade;
marking the positions where cut;
peeling a back tape off the latch side of the hooks and loops fastener strip and placing the strip so that it will adhere to the back side of the shade where the guide ring was detached;
feeding a soft side of the hooks and loops fastener through the guide ring and positioning the ring in the center of the hooks and loops fastener strip;
pressing the strips to attach; and
repeating this process for all the guide rings.

5. A kit for retrofitting a Roman Shade with a cord release comprising:
a plurality of hooks and loops fastener strips for bottom rings of a Roman Shade;
a plurality of hooks and loops fastener strips for guide rings of a Roman Shade and a set of instructions for retro fitting a Roman shade that includes the following:
cutting strings that are attached to each bottom ring of the back of the Roman Shade;
marking each of position where each string was cut for each of said bottom rings;
peeling off a backing of a hooks and loops fastener strip for each bottom ring from its latch side and placing each strip to adhere to the back side of the Roman Shade where each bottom ring was detached;
feeding the soft side of the hooks and loops fastener through each ring and positioning each bottom ring in the center of the hooks and loops fastener strip;
attaching the strips by pressing the strips and repeating for each bottom ring;
cutting the strings that attach the guide rings to the back of the shade;
marking the positions where cut;
peeling off a back tape off the latch side of the hooks and loops fastener strip and placing the strip to adhere to the back of the shade where the guide ring was detached;
feeding a soft side of the hooks and loops fastener through the guide ring and positioning the ring in the center of the hooks and loops fastener strip;
pressing the strips to attach; and
repeating this process for all the guide rings.

6. The kit according to claim 5 wherein there are three hooks and loops fastener strips for the bottom rings and these fastener strips are 1½ inches in length by ⅜ of an inch in width.

7. The kit according to claim 5 wherein there are eight hooks and loops fastener strips for the guide rings and they are preferably ¾ of an inch in length by ⅜ of an inch in width.
